(19) United States
(12) Patent Application Publication
(10) Pub. No.: US 2006/0077800 A1
(43) Pub. Date: Apr. 13, 2006

(54) METHOD AND DEVICE FOR DETERMINING SLICING LEVEL OF TRACK-CROSSING SIGNAL

(76) Inventors: Hsiang-Ji Hsieh, Taipei Hsien (TW); Ya-Lun Yang, Hsin-Chu Hsien (TW); Yu-Hsin Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/162,364

(22) Filed: Sep. 8, 2005

(30) Foreign Application Priority Data
Sep. 10, 2004 (TW) 093127601

(51) Int. Cl. G11B 7/00

(52) U.S. Cl. 369/44.27; 369/44.28; 369/44.34

(57) ABSTRACT

The present invention provides a method and a related device for determining a slicing level of a track-crossing signal. The method includes reading a Track Error Zero Crossing (TEZC) signal of an optical storage device, reading the track-crossing signal such as a Radio Frequency Ripple (RFRP) signal of the optical storage device, sampling a peak level and a bottom level from the track-crossing signal according to the track-crossing signal and the TEZC signal, and determining a level between the peak level and the bottom level as the slicing level.

### BACKGROUND

The present invention relates to an optical storage control method for determining a slicing level of a track-crossing signal.

When performing track searching on an optical storage disc, an optical storage device typically generates a Track Error Zero Crossing (TEZC) signal according to a Track Error (TE) signal of the optical storage device, and a sliced track-crossing signal according to a track-crossing signal of the optical storage device, e.g. a Radio Frequency Ripple (RFRP) signal. In addition, the optical storage device typically determines a track-crossing direction of an Optical Pickup (OPU) of the optical storage device to be outward track-crossing or inward track-crossing according to the TEZC signal and the sliced track-crossing signal.

Please refer to FIG. 1, which illustrates a diagram of a circuit 100 for slicing a track-crossing signal according to the related art. The circuit 1 00 includes a slicing level generator 110 for generating a slicing level RX_SL according to the RFRP signal, wherein the slicing level generator 110 is a low pass filter (LPF). Only when the slicing level generator 110 properly generates the slicing level RX_SL, may the comparator 120 correctly convert the RFRP signal into the sliced track-crossing signal RX according to the slicing level RX_SL. The sliced track-crossing signal RX can be utilized for controlling the optical storage device. A response time of the slicing level generator 110 corresponds to the impedance formed with the resistor RO and the capacitor CO.

Please refer to FIG. 2, which illustrates a diagram of a circuit 200 for slicing a track-crossing signal according to the related art. The circuit 200 includes a slicing level generator 210 for generating a slicing level RX_SL according to the RFRP signal, wherein the slicing level generator 210 includes a peak level holder 212 and a bottom level holder 214. Similarly, only when the slicing level generator 210 properly generates the slicing level RX_SL, may the comparator 120 correctly convert the RFRP signal into the sliced track-crossing signal RX according to the slicing level RX_SL. Whether the slicing level generator 210 properly generates the slicing level RX_SL or not is influenced by the capacitance of the capacitors C1 and C2.

When a dynamic range of the RFRP signal is suddenly changed because the OPU crosses a common boundary between a data region and a blank region of the optical storage disc, or because of some other reason, the slicing level generators 110 and 210 mentioned above cannot properly generate the slicing level RX_SL in accordance with the changed dynamic range in real time.

### SUMMARY

Methods and circuits for determining a slicing level of a track-crossing signal are disclosed. An exemplary embodiment of a method for determining a slicing level of a track-crossing signal comprises: reading a Track Error Zero Crossing (TEZC) signal of an optical storage device; reading a track-crossing signal of the optical storage device, e.g. a Radio Frequency Ripple (RFRP) signal; sampling a peak level and a bottom level from the RFRP signal according to the RFRP signal and the TEZC signal; and determining a level between the peak level and the bottom level as the slicing level.

An exemplary embodiment of a circuit for determining a slicing level of a track-crossing signal comprises: a control unit coupled to an optical storage device for generating a peak level sampling trigger signal and a bottom level sampling trigger signal according to a TEZC signal and the track-crossing signal of the optical storage device, e.g. an RFRP signal; a first sample and hold circuit coupled to the optical storage device and the control unit for sampling a peak level from the RFRP signal according to the peak level sampling trigger signal, the peak level being utilized as an output of the first sample and hold circuit; a second sample and hold circuit coupled to the optical storage device and the control unit for sampling a bottom level from the RFRP signal according to the bottom level sampling trigger signal, the bottom level being utilized as an output of the second sample and hold circuit; and a slicing level generating unit coupled to the first sample and hold circuit and the second sample and hold circuit for determining a level between the peak level and the bottom level as the slicing level.

### BRIEF DESCRIPTION OF THE DRAWINGS

FIG. 1 is a diagram of a circuit for slicing a track-crossing signal according to the related art.

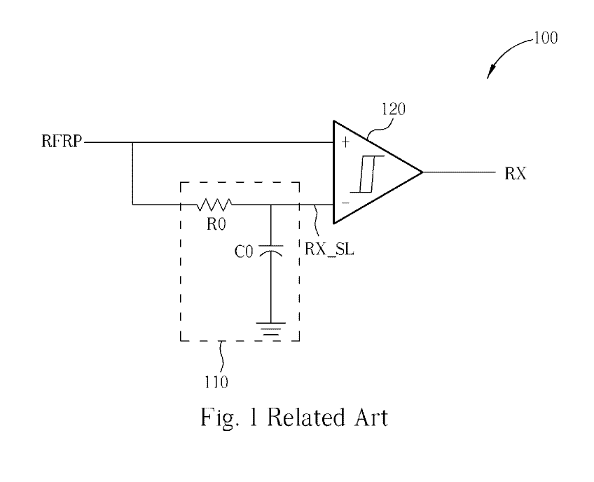

FIG. 2 is a diagram of a circuit for slicing a track-crossing signal according to the related art.

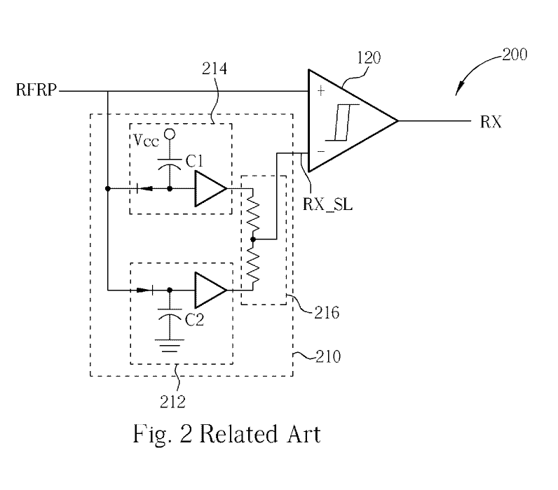

FIG. 3 is a flowchart of a method for determining a slicing level of a track-crossing signal.

FIG. 4 is a diagram of a related device of the method shown in FIG. 3.

FIG. 5 is a diagram of related signals of the method shown in FIG. 3.

FIG. 6 is a diagram of related signals of the method shown in FIG. 3.

### DETAILED DESCRIPTION

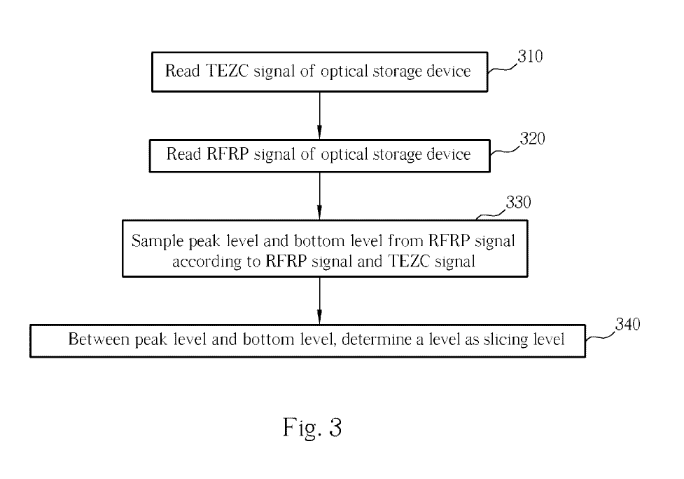

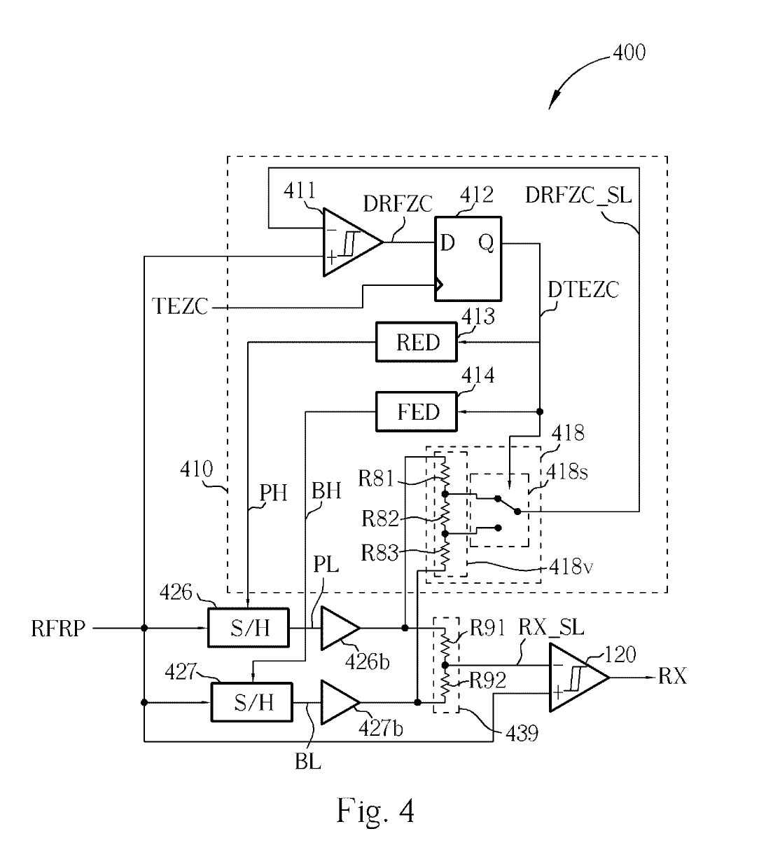

Please refer to FIG. 3 and FIG. 4. FIG. 3 is a flowchart of a method for determining a slicing level of a track-crossing signal according to one embodiment of the present invention. FIG. 4 is a diagram of a related device of the method shown in FIG. 3. Although an optical storage device in this embodiment can be, but not limited to, a DVD drive or a CD drive. The present invention provides a method for determining a slicing level RX_SL of a track-crossing signal. In this embodiment, the track-crossing signal mentioned above is an RFRP signal. Other kinds of track-crossing signals can be applied. The method is described as follows:

Step 310: Read a Track Error Zero Crossing (TEZC) signal of an optical storage device utilizing the control unit 410 shown in FIG. 4.

Step 320: Read a track-crossing signal of the optical storage device, e.g. a Radio Frequency Ripple (RFRP) signal, utilizing the control unit 410.

Step 330: Sample a peak level PL and a bottom level BL from the RFRP signal according to the RFRP signal and the TEZC signal utilizing the control unit 410, the first sample and hold circuit 426, and the second sample and hold circuit 427 shown in FIG. 4.

Step 340: Determine a level between the peak level PL and the bottom level BL as the slicing level RX_SL utilizing the slicing level generating unit 439 shown in FIG. 4.

The control unit 410, the first sample and hold circuit 426, the second sample and hold circuit 427, and the slicing level generating unit 439 form a circuit for determining the slicing level RX_SL of the track-crossing signal (i.e. the RFRP signal) as shown in FIG. 4. When a dynamic range of the RFRP signal is suddenly changed, the slicing level RX_SL can be properly generated in accordance with the changed dynamic range in real time utilizing the circuit mentioned above, so as to maintain the correctness of a sliced track-crossing signal RX generated according to the slicing level RX_SL.

The control unit 410 is capable of generating a peak level sampling trigger signal PH and a bottom level sampling trigger signal BH according to the TEZC signal and the RFRP signal, where the peak level sampling trigger signal PH and the bottom level sampling trigger signal BH in this embodiment are pulse signals, and are generated when the TEZC signal inverts. The peak level sampling trigger signal PH and the bottom level sampling trigger signal BH are respectively utilized for triggering the first sample and hold circuit 426 and the second sample and hold circuit 427. The control unit 410 determines whether to generate the peak level sampling trigger signal PH or the bottom level sampling trigger signal BH according to a level of the RFRP signal, and therefore, in Step 330, a sampling result can be properly determined to be the peak level PL or the bottom level BL when the TEZC signal inverts. The operations mentioned above are described in detail in the following.

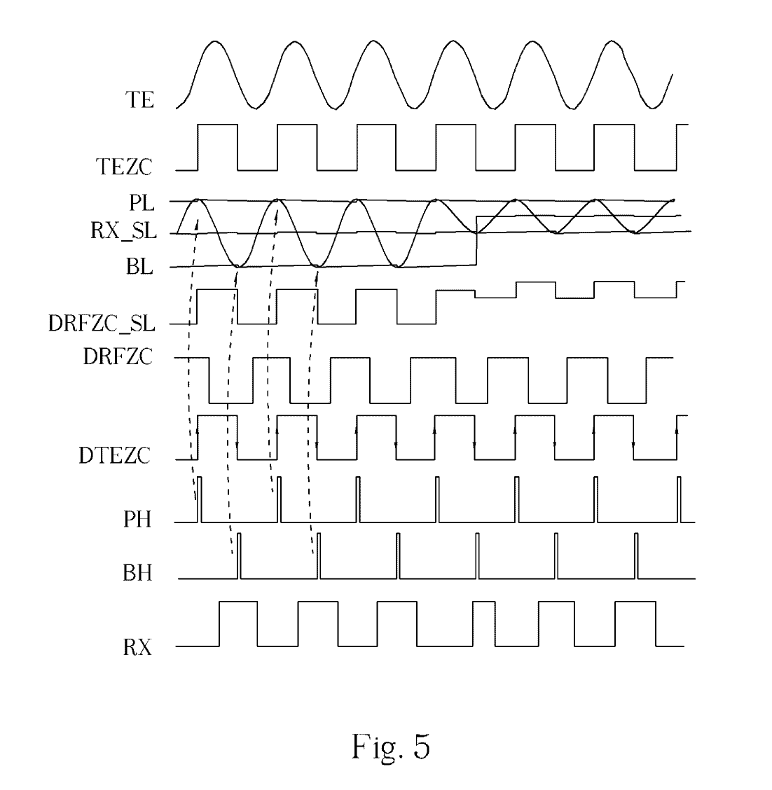

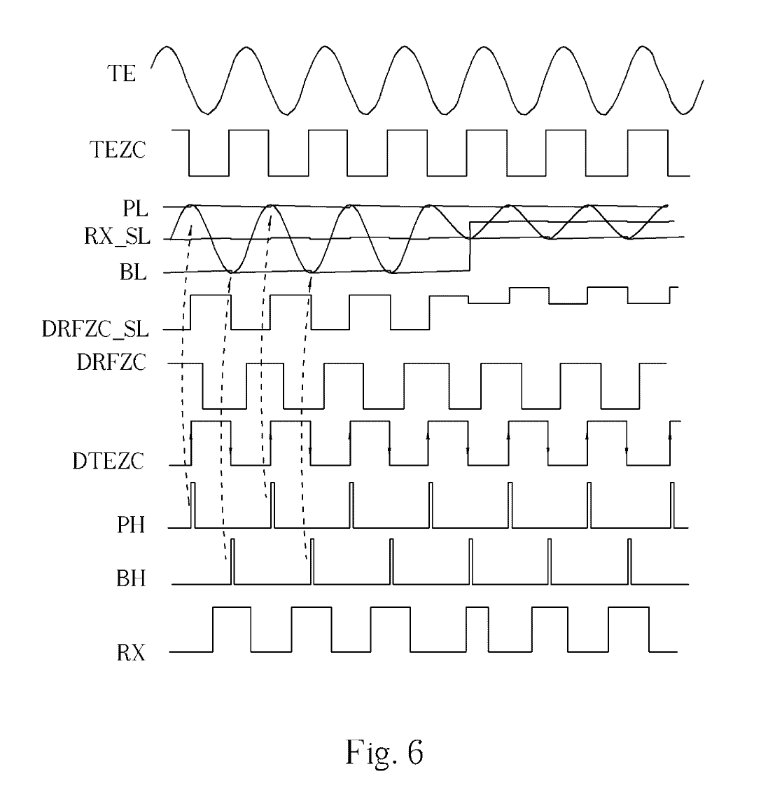

As shown in FIG. 4, the control unit 410 comprises a first comparator 411, a sequential circuit 412, a rising edge detector 413, a falling edge detector 414, and a weighted average unit 418. According to a feedback level generated by the weighted average unit 418, i.e. the digital Radio Frequency Zero Crossing (RFZC) slicing signal DRFZC_SL, the first comparator 411 is capable of comparing the RFRP signal and the digital RFZC slicing signal DRFZC_SL, where the comparison result is the digital RFZC (DRFZC) signal. In this embodiment, the sequential circuit 412 is a flip flop, whose input clock is the TEZC signal. When the TEZC signal inverts, the sequential circuit 412 latches the DRFZC signal to generate a digital TEZC (DTEZC) signal. No matter whether in the outward track-crossing situation shown in FIG. 5 or in the inward track-crossing situation shown in FIG. 6, the rising edge detector 41 3 generates the peak level sampling trigger signal PH when detecting a rising edge of the DTEZC signal. As soon as the first sample and hold circuit 426 is triggered by the peak level sampling trigger signal PH, the first sample and hold circuit 426 samples the peak level PL from the RFRP, wherein the peak level PL is utilized as an output of the first sample and hold circuit 426, and the level of the peak level PL outputted by the first sample and hold circuit 426 is maintained till a re-sampled peak level is generated in the next operation. Similarly, no matter whether in the outward track-crossing situation shown in FIG. 5 or in the inward track-crossing situation shown in FIG. 6, the falling edge detector 414 generates the bottom level sampling trigger signal BH when detecting a falling edge of the DTEZC signal. As soon as the second sample and hold circuit 427 is triggered by the bottom level sampling trigger signal BH, the second sample and hold circuit 427 samples the bottom level BL from the RFRP, wherein the bottom level BL is utilized as an output of the second sample and hold circuit 427, and the level of the bottom level BL outputted by the second sample and hold circuit 427 is maintained till a re-sampled bottom level is generated in the next operation.

As shown in FIG. 4, the weighted average unit 418 comprises a voltage dividing circuit 418v and a switch 418s. The voltage dividing circuit 418v is coupled to the first sample and hold circuit 426 through a buffer 426b and is coupled to the second sample and hold circuit 427 through a buffer 427b. As a result, resistors R81, R82, and R83 of the voltage dividing circuit 418v are capable of performing a weighted average operation on the peak level PL outputted by the first sample and hold circuit 426 and the bottom level BL outputted by the second sample and hold circuit 427, where the ratio of the resistance of the resistor R81 to the resistance of the resistor R82 to the resistance of the resistor R83=1:2:1. Here, at least one operation result of the weighted average operation, i.e. a voltage dividing signal outputted through a node between the resistors R81 and R82 and/or a voltage dividing signal outputted through a node between the resistors R82 and R83, can be generated. The switch 418s is capable of switching the voltage that the weighted average unit 418 should output, i.e. the voltage of one of the voltage dividing signals mentioned above, according to a status of the DTEZC signal. When the DTEZC signal is at a high level, representing that the first sample and hold circuit 426 has just finished sampling the peak level PL from the RFRP, the level of the digital RFZC slicing signal DRFZC_SL is equal to a summation of three quarters of the level of the peak level PL and one quarter of the level of the bottom level BL. When the DTEZC signal is at a low level, representing that the second sample and hold circuit 427 has just finished sampling the bottom level BL from the RFRP, the level of the digital RFZC slicing signal DRFZC_SL is equal to a summation of one quarter of the level of the peak level PL and three quarters of the level of the bottom level BL. When the dynamic range of the RFRP signal is suddenly changed because an Optical Pickup (OPU) of the optical storage device crosses a common boundary between a burned region (e.g. a data region) and an unburned region (e.g. a blank region) of an optical storage disc or because of some other reason, the level of the digital RFZC slicing signal DRFZC_SL is maintained between the maximum and the minimum values of the RFRP signal, so as to maintain the operation sequences of the DRFZC signal and the DTEZC signal shown in FIG. 5 and FIG. 6. Therefore, with the feedback level being the digital RFZC slicing signal DRFZC_SL generated by the weighted average operation that alternately switches the weighted values thereof, the control unit 410 is capable of properly generating the peak level sampling trigger signal PH and the bottom level sampling trigger signal BH in real time, so the first sample and hold circuit 426 may accurately sample the peak level PL from the RFRP at a time point when a maximum of the RFRP occurs and the second sample and hold circuit 427 may sample the bottom level BL from the RFRP at a time point when a minimum of the RFRP occurs.

Through the accurate control of the control unit 410 on sampling timing, the peak level PL outputted by the first sample and hold circuit 426 and the bottom level BL outputted by the second sample and hold circuit 427 are outputted to the slicing level generating unit 439 respectively through the buffering performed by the buffers 426b and 427b. The slicing level generating unit 439 determines a level between the peak level PL and the bottom level BL as the slicing level RX_SL. In this embodiment, the slicing level generating unit 439 is a voltage dividing circuit consisting of two resistors R91 and R92 having the same resistance value, and the slicing level RX_SL is a voltage dividing signal generated by the voltage dividing circuit. As a result, the slicing level RX_SL is an average of the peak level PL and the bottom level BL. As shown in FIG. 5 and FIG. 6, in accordance with the peak level PL and the bottom level BL generated under the accurate control of the control unit 410 on sampling timing, the slicing level RX_SL generated by the slicing level generating unit 439 is maintained to be the average of the peak level PL and the bottom level BL. Therefore, the slicing level RX_SL is always maintained at a level exactly in the middle of the dynamic range of the RFRP signal. No matter whether the OPU is in the outward track-crossing situation or the inward track-crossing situation, the slicing level RX_SL can be properly generated in real time, so the sliced track-crossing signal RX can be correctly generated according to the slicing level RX_SL.

What is claimed is:

1. A method for determining a slicing level of a track-crossing signal, comprising:
reading a Track Error Zero Crossing (TEZC) signal of an optical storage device;
reading a track-crossing signal of the optical storage device;
sampling a peak level and a bottom level from the track-crossing signal according to the track-crossing signal and the TEZC signal; and
determining a level between the peak level and the bottom level as the slicing level.

2. The method of claim 1, wherein the track-crossing signal is a Radio Frequency Ripple (RFRP) signal.

3. The method of claim 1, wherein the step of sampling the peak level and the bottom level from the track-crossing signal further comprises:
sampling the track-crossing signal when the TEZC signal inverts; and
determining a sampling result to be the peak level or the bottom level according to a level of the track-crossing signal.

4. The method of claim 3, wherein the step of sampling the peak level and the bottom level from the track-crossing signal further comprises:
comparing the track-crossing signal with a first signal utilizing a comparator to generate a second signal;
when the TEZC signal inverts, latching the second signal utilizing a sequential circuit to generate a third signal;
sampling the peak level from the track-crossing signal when a rising edge of the third signal is detected;
sampling the bottom level from the track-crossing signal when a falling edge of the third signal is detected; and
performing a weighted average operation on the peak level and the bottom level to generate the first signal.

5. The method of claim 4, wherein the sequential circuit is a flip flop.

6. The method of claim 4, wherein the step of sampling the peak level from the track-crossing signal further comprises:
generating a peak level sampling trigger signal utilizing a rising edge detector; and
generating the peak level utilizing a sample and hold circuit according to the peak level sampling trigger signal.

7. The method of claim 4, wherein the step of sampling the bottom level from the track-crossing signal further comprises:
generating a bottom level sampling trigger signal utilizing a falling edge detector; and
generating the bottom level utilizing a sample and hold circuit according to the bottom level sampling trigger signal.

8. The method of claim 4, further comprising:
switching weighted values of the step of performing the weighted average operation according to a status of the third signal.

9. The method of claim 8, wherein in the step of performing the weighted average operation, a weighted value corresponding to the peak level is greater than a weighted value corresponding to the bottom level when the third signal is at a high level, and a weighted value corresponding to the peak level is less than a weighted value corresponding to the bottom level when the third signal is at a low level.

10. The method of claim 1, wherein the slicing level is an average of the peak level and the bottom level.

11. A circuit for determining a slicing level of a track-crossing signal, comprising:
a control unit coupled to an optical storage device for generating a peak level sampling trigger signal and a bottom level sampling trigger signal according to the track-crossing signal of the optical storage device and a Track Error Zero Crossing (TEZC) signal of the optical storage device;
a first sample and hold circuit coupled to the optical storage device and the control unit for sampling a peak level from the track-crossing signal according to the peak level sampling trigger signal, the peak level being utilized as an output of the first sample and hold circuit;
a second sample and hold circuit coupled to the optical storage device and the control unit for sampling a bottom level from the track-crossing signal according to the bottom level sampling trigger signal, the bottom level being utilized as an output of the second sample and hold circuit; and
a slicing level generating unit coupled to the first sample and hold circuit and the second sample and hold circuit for determining a level between the peak level and the bottom level as the slicing level.

12. The circuit of claim 11, wherein the track-crossing signal is a Radio Frequency Ripple (RFRP) signal.

13. The circuit of claim 11, wherein the control unit is capable of triggering the first sample and hold circuit utilizing the peak level sampling trigger signal when the TEZC signal inverts to sample the peak level, the control unit is capable of triggering the second sample and hold circuit utilizing the bottom level sampling trigger signal when the TEZC signal inverts to sample the bottom level, and the control unit determines whether to sample the peak level or the bottom level according to a level of the track-crossing signal.

14. The circuit of claim 11, wherein the peak level sampling trigger signal and the bottom level sampling trigger signal are pulse signals.

15. The circuit of claim 11, wherein the control unit further comprises:
a first comparator coupled to the optical storage device for comparing the track-crossing signal with a first signal to generate a second signal;
a sequential circuit coupled to the optical storage device and the first comparator, the sequential circuit latching the second signal to generate a third signal when the TEZC signal inverts;
a rising edge detector coupled to the sequential circuit and the first sample and hold circuit for detecting a rising edge of the third signal to generate the peak level sampling trigger signal;
a falling edge detector coupled to the sequential circuit and the second sample and hold circuit for detecting a falling edge of the third signal to generate the bottom level sampling trigger signal; and
a weighted average unit coupled to the first sample and hold circuit, the second sample and hold circuit, and the first comparator for performing a weighted average operation on the peak level and the bottom level to generate the first signal.

16. The circuit of claim 15, wherein the sequential circuit is a flip flop.

17. The circuit of claim 15, wherein the weighted average unit is further coupled to the sequential circuit, and the weighted average unit is capable of switching weighted values of the weighted average operation according to a status of the third signal.

18. The circuit of claim 17, wherein a weighted value corresponding to the peak level is greater than a weighted value corresponding to the bottom level when the third signal is at a high level, and a weighted value corresponding to the peak level is less than a weighted value corresponding to the bottom level when the third signal is at a low level.

19. The circuit of claim 15, wherein the weighted average unit further comprises:
a voltage dividing circuit coupled to the first sample and hold circuit, the second sample and hold circuit, and the first comparator for generating a voltage dividing signal as the first signal; and
a switch coupled to the sequential circuit, the voltage dividing circuit, and the first comparator for switching the voltage of the voltage dividing signal according to a status of the third signal.

20. The circuit of claim 14, wherein the slicing level is an average of the peak level and the bottom level.

21. The circuit of claim 14, wherein the slicing level generating unit is a voltage dividing circuit, and the slicing level is a voltage dividing signal generated by the voltage dividing circuit.

22. The circuit of claim 14, further comprising:
a first buffer coupled to the first sample and hold circuit and the slicing level generating unit for buffering the peak level; and
a second buffer coupled to the second sample and hold circuit and the slicing level generating unit for buffering the bottom level.
